(19) United States
(12) Patent Application Publication
(10) Pub. No.: US 2003/0067917 A1
(43) Pub. Date: Apr. 10, 2003

(54) IGMP proxy

(75) Inventors: Lynne Christine Morrison, Southboro, MA (US); Igor Lasic, Newton, MA (US); Prabir Datta, Marlborough, MA (US)

Correspondence Address: Fogg Slifer Polgiaze Leffert & Jay, P.A., P. O. Box 581009, Minneapolis, MN, 55458-1009, US

(73) Assignee: ADC Broadband Access Systems, Inc.

(21) Appl. No.: 10/264,493

(22) Filed: Oct. 4, 2002

Related U.S. Application Data
(60) Provisional application No. 60/327,197, filed on Oct. 4, 2001.

(51) Int. Cl. H04L 12/28

(52) U.S. Cl. 370/390; 370/392

(57) ABSTRACT

A method for internet groups management protocol proxying having a backup proxy configured as a secondary interface backing up a primary interface uses metrics and monitoring to switch interfaces upon failure of the primary interface.

The present invention relates generally to communications, and more specifically to internet groups management protocol (IGMP) proxy.

### BACKGROUND

In the area of telecommunications, a fairly recent development is the use of multicast technology to broadcast a single packet of network information to a number of host recipients at the same time. Multicast is a scheme in which a number of destinations on a network wish to receive the same information, for example on a video server or the like. Instead of sending the information numerous times, once to each destination, from the video server, the information is instead sent to a multicast group. A multicast group is a group on a server, router, or the like, to which various user hosts can join indicating their desire to receive information. The information is sent from the video server or the like to the multicast group. The multicast group routers receive the packet and duplicate it only to those hosts that have indicated their desire to receive the information.

Internet Group Management Protocol (IGMP) is required by all hosts and routers wishing to receive multicast packets. If a host wishes to receive multicast traffic from a specific multicast group it must join that group. IGMP is used by IP hosts to report multicast group membership to a local router. The router issues IGMP Queries periodically to learn which multicast groups exist on a network. Hosts reply to the queries with IGMP Report messages consisting of the multicast groups that they wish to belong to. The router uses these IGMP Report messages to keep track of multicast groups on a network. One instance of IGMP is run on each interface. Even if two IP networks are configured on an interface, only one instance of IGMP is run. Each instance of IGMP only knows about the multicast groups on its interface. It has no knowledge of the multicast group memberships on other interfaces within the chassis.

A router that supports multicast functionality must provide a method to forward multicast packets it receives on one interface to all other interfaces that have hosts that belong to the multicast group. When a router runs IGMP it learns which multicast groups have attached hosts that wish to receive packets. The router must let a multicast router know about these groups that its attached hosts want to receive packets for. There are two ways to let multicast routers know about multicast groups the hosts have joined. The first method is to run a multicast routing protocol such as a protocol independent multicast (PIM) or distance vector multicast routing protocol (DVMRP). The second method is to run IGMP proxy. IGMP proxy is a simple method to let a multicast router know about multicast groups that hosts, which are not directly connected to this router, want to receive traffic for.

Standard IGMP Proxy RFC contemplates only a single upstream interface. There is no provision within IGMP Proxy for any backup in case of interface failure. In the case of interface failure, a connection to the server supplying information is lost, and therefore the feed of information to the various hosts connected to the multicast group is also lost.

There is therefore a need in the art for backup proxies in IGMP Proxy.

### SUMMARY

In one embodiment, a method of providing multiple upstream interfaces in an internet groups management protocol proxy includes configuring a range of multicast proxy addresses to a first upstream interface having a first metric, and configuring the range of multicast proxy addresses to a second upstream interface having a second metric greater than the first metric.

In another embodiment, a method of providing a backup proxy in an IGMP proxy includes enabling a first interface containing a range of multicast addresses, and enabling a second interface containing the range of multicast addresses. When requests for packet routing are presented, packet requests for the range of multicast addresses are routed to the first interface when the first interface is available, and are routed to the second interface when the first interface is not available.

In yet another embodiment, a method of configuring an IGMP proxy includes providing a number of proxy interfaces for a number of multicast proxy address ranges, and configuring the proxy interfaces based on the address ranges.

In still another embodiment, a method of operating an internet groups management protocol proxy includes assigning a range of multicast addresses to a first interface having a first priority metric, and assigning the range of multicast addresses to a second interface having a second priority metric of lower priority than the first priority metric.

In still yet another embodiment, a method for providing multiple interfaces in an IGMP proxy includes assigning a primary priority level to a first interface on the IGMP Proxy, assigning a secondary priority level to a second interface on the IGMP Proxy, monitoring a status of the first interface, and switching to the second interface when the first interface is unavailable.

Other embodiments are described and claimed.

### BRIEF DESCRIPTION OF THE DRAWINGS

FIG. 1 is a flow chart diagram of a method according to one embodiment of the present invention;

FIG. 2 is a flow chart diagram of a method according to another embodiment of the present invention;

FIG. 3 is a flow chart diagram of a method according to yet another embodiment of the present invention;

FIG. 4 is a flow chart diagram of a method according to still another embodiment of the present invention;

FIG. 5 is a block diagram of a router employing embodiments of the present invention; and

FIG. 6 is a block diagram of a computer on which embodiments of the present invention are practiced.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

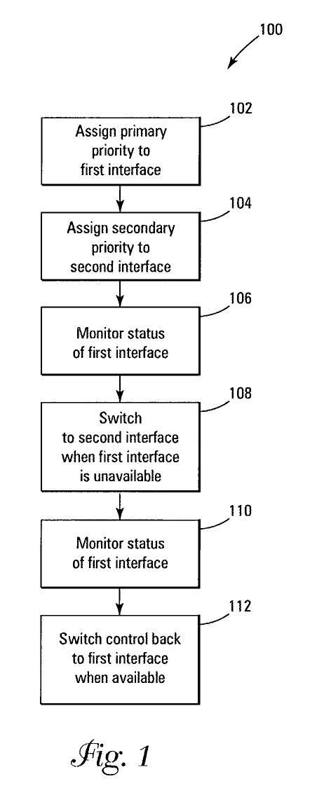

FIG. 1 is a flow chart diagram of a method 100 according to one embodiment of the present invention. Method 100 for providing multiple interfaces in an IGMP Proxy comprises assigning a primary priority level to a first interface on the IGMP Proxy in block 102, and assigning a secondary priority level to a second interface on the IGMP Proxy in block 104. The status of the first interface is monitored to determine if the interface is still available in block 106. If the first interface becomes unavailable, for example for a loss of connection, power outage, or the like, then proxying is switched to the second interface in block 108.

Once the first interface becomes unavailable for some reason, and the second interface takes over for the proxying, the availability of the first interface continues to be monitored in block 110, and proxy control switches back to the first interface from the second interface in block 112 when the first interface becomes available again.

In one embodiment, the primary and secondary priority levels assigned to interfaces are based on metric. That is, the lower the metric of the assignment, the higher the priority. In one embodiment, the first interface is assigned a metric of one (1) and the second interface is assigned a metric of two (2). The lower metric takes priority, so any traffic for the specific range of proxy multicast addresses will determine the metrics of the available interfaces, and traffic is routed to the lowest metric, that is the highest priority, interface. If the highest priority metric interface is not available, the backup, or secondary, metric interface is used for the traffic.

It should be understood that while two separate interfaces with different metrics for the same range of addresses have been described, further embodiments with greater numbers of interfaces and metrics are also within the scope of the invention.

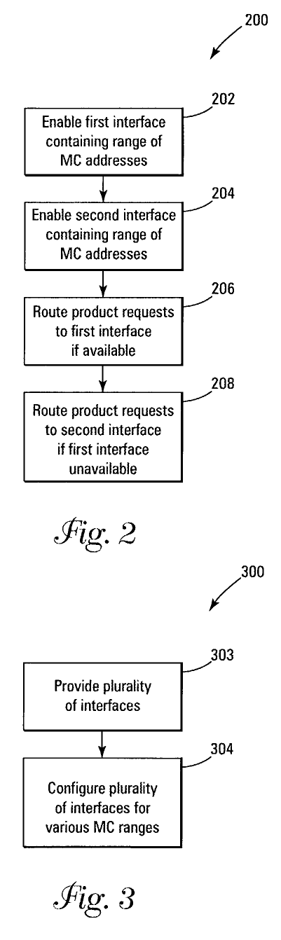

FIG. 2 is a flow chart diagram of a method 200 for providing multiple upstream interfaces in an IGMP Proxy environment. Method 200 comprises enabling a first interface containing a range of multicast addresses in block 202, and enabling a second interface containing the same range of multicast addresses in block 204. Each of the first and the second interfaces proxies the same range of addresses. In block 206, packet requests for an address in the range of multicast addresses are routed to the first interface in block 206 when the first interface is available. In block 208, packet requests for an address in the range of multicast addresses are routed to the second interface in block 208 when the first interface is not available.

Availability of the first interface is determined in one embodiment by monitoring the first interface for an alarm or other interruption of availability. In one embodiment, the first and the second interfaces are each assigned a priority metric that determines which of the interfaces is the primary interface for the address range and which of the interfaces is the secondary interface for the address range. In this embodiment, the priority metric for the first interface is a higher priority metric, which in one embodiment is determined by its having the lowest value, and the priority metric for the second interface is a lower priority metric. For example, in one embodiment, the first interface is assigned a metric of one (1) and the second interface is assigned a metric of two (2). Each of the interfaces is proxying the same multicast address range, but one of the interfaces is the primary interface, and one is the backup interface.

For example, there is a set of multicast addresses associated with a particular proxy group. In one embodiment there is a configured interface X for the groups of addresses having an assigned metric of 1. For a backup interface Y, the same range of addresses is configured for example on interface Y and is assigned a metric of 2 (lower priority). When a request for a packet is received at the router or whatever apparatus is operating the IGMP proxy, a check is made for the availability of the interface having the lowest metric. In this example, the interface X is the lowest metric, and is therefore the primary interface. The interface Y range of addresses with metric 2 is the lower priority, or backup, interface. Whenever there is an alarm on interface X, such as for a lost connection or the like, the interface is switched to the metric 2 interface, which in this embodiment is interface Y with a metric of 2. The switch is performed automatically in response to an alarm or other predetermined error condition on the interface X.

For further example, suppose a lower metric interface among two interfaces loses its connection or has an alarm condition. The condition is continuously monitored in one embodiment, and when a loss of signal or alarm condition is indicated on the interface having the lower metric, the interface is switched, in response, to the next lowest interface metric. The lower metric interface is still monitored in one embodiment, and when the lower metric interface is again available without alarm or error conditions, a switchover is again made, this time from the lower priority metric to the higher priority metric.

Only one interface is used at a time, but multiple interfaces are available, allowing a backup proxy. If a multicast address range is configured with a metric 1, its interface has the highest priority for traffic on the system. If the same address range is configured on a different interface with a metric of 2, it is the backup interface.

FIG. 3 is a flow chart diagram of one embodiment of a method 300 for configuring an internet group management protocol (IGMP) proxy. Method 300 comprises providing a plurality of proxy interfaces for a plurality of multicast proxy address ranges in block 302, and configuring the plurality of proxy interfaces based on the plurality of address ranges in block 304. In one embodiment, the method also comprises providing a backup proxy for at least one of the plurality of ranges of multicast proxy addresses in block 306.

In various embodiments, providing a backup proxy is performed in several different ways. In one embodiment, shown in FIG. 4, a method 400 for providing a backup proxy is shown. Method 400 comprises assigning at least one of the plurality of ranges of multicast proxy addresses a priority metric in block 402, assigning a backup interface to the at least one of the plurality of ranges of multicast proxy addresses in block 404, and assigning the backup interface secondary metric in block 406. In one embodiment, packets are routed according to the availability of the first and the second interfaces. The packets are initially all routed to the interface having the lowest metric. If, however, that interface is not available for some reason, then the packets are routed to the interface having the next lowest metric, the backup interface in this embodiment. In one embodiment, the priority metric is a lower value than the secondary metric.

In various IGMP Proxy embodiments of the present invention, a proprietary management information base (MIB) table is defined which implements the ability to enable a user to configure a range of proxy multicast addresses for an interface table. The MIB also routes metric associated with it, allowing in one embodiment the assignment of weight to a particular proxy group to allow support of backup proxies as described above.

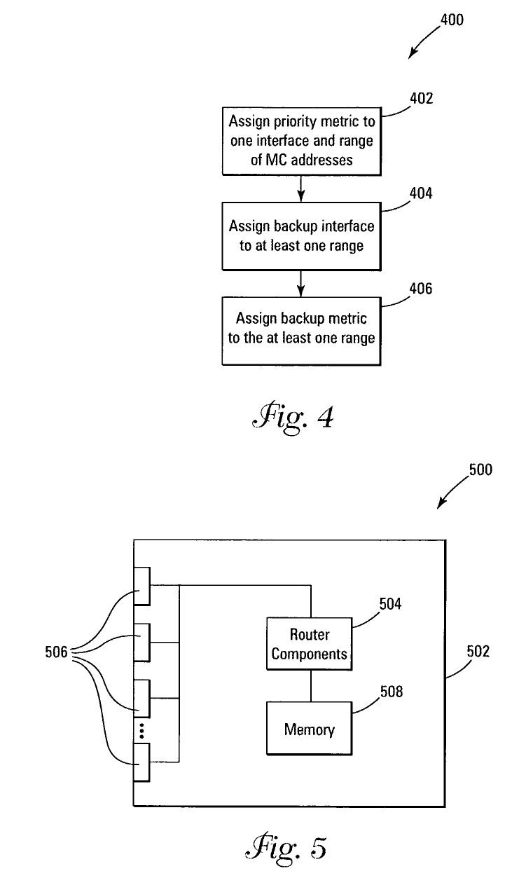

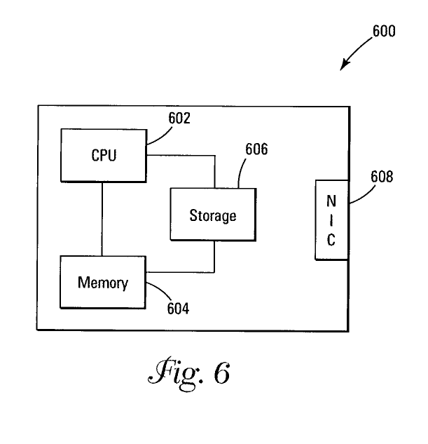

FIG. 5 is a block diagram of a router 500 employing embodiments of the present invention. Router 500 comprises a router body 502 housing standard router components 504, and having a plurality of network connections 506, which are a combination of incoming and outgoing network connections. The router 500 runs an IGMP proxy which is in one embodiment stored in router memory 508. The IGMP proxy is in various embodiments an IGMP proxy with a backup feature as has been described above with respect to FIGS. 1, 2, 3, and 4.

It should be understood that the IGMP proxy embodiments of the present invention are implementable not only on a single chassis, but also are expandable to a cluster, and such expansion is within the scope of the invention.

The methods shown in FIGS. 1, 2, 3, and 4 may be implemented in whole or in part in various embodiments in a machine readable medium comprising machine readable instructions for causing a router or a computer such as is shown in FIGS. 5 and 6 to perform the methods. In computer 600, the computer programs run on the central processing unit 602 out of main memory 604, and may be transferred to main memory from permanent storage 606 via disk drive or CD-ROM drive when stored on removable media or via a network connection 608 or modem connection when stored outside of the computer 600, or via other types of computer or machine readable media from which it can be read and utilized. In router 500, the computer programs run on a router processor in router memory.

Such machine readable media may include software modules and computer programs. The computer programs may comprise multiple modules or objects to perform the methods in FIGS. 1, 2, 3, and 4 or the functions of various apparatuses of FIGS. 5 and 6. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

### CONCLUSION

Multiple proxy interfaces including primary and backup interfaces for the same range of multicast addresses are provided in various embodiments of the present invention. In various embodiments, primary and backup interfaces are determined through the use of metrics giving weight to the various interfaces. If a primary interface fails or goes down for some reason, the embodiments of the present invention swap control to a secondary interface automatically.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method of providing multiple upstream interfaces in an IGMP Proxy
configuring a range of multicast proxy addresses to a first upstream interface having a first metric; and
configuring the range of multicast proxy addresses to a second upstream interface having a second metric greater than the first metric.

2. The method of claim 1, and further comprising:
monitoring the first upstream interface for availability; and
switching a multicast to the second upstream interface when the first upstream interface becomes unavailable.

3. A method of providing a backup proxy in an IGMP proxy, comprising:
enabling a first interface containing a range of multicast addresses;
enabling a second interface containing the range of multicast addresses;
routing packet requests for the range of multicast addresses to the first interface when the first interface is available; and
routing packet requests for the range of multicast addresses to the second interface when the first interface is not available.

4. The method of claim 3, wherein routing packet requests to the first interface comprises:
monitoring the availability of the first interface; and
routing packets to the first interface any time the first interface is available.

5. The method of claim 3, wherein enabling a first interface comprises:
assigning the range of multicast addresses to the first interface; and
assigning a priority metric to the first interface.

6. The method of claim 3, wherein enabling a second interface comprises:
assigning the range of multicast addresses to the second interface; and
assigning a secondary metric to the second interface.

7. A method of configuring an internet group management protocol (IGMP) proxy, comprising:
providing a plurality of proxy interfaces for a plurality of multicast proxy address ranges; and
configuring the plurality of proxy interfaces based on the plurality of address ranges.

8. The method of claim 7, and further comprising:
providing a backup proxy for at least one of the plurality of ranges of multicast proxy addresses.

9. The method of claim 8, wherein providing a backup proxy comprises:
assigning the at least one of the plurality of ranges of multicast proxy addresses a priority metric;
assigning a backup interface to the at least one of the plurality of ranges of multicast proxy addresses; and
assigning the backup interface secondary metric.

10. The method of claim 7, and further comprising:
routing packet requests according to the availability of the first and the second interfaces.

11. The method of claim 10, wherein routing packet requests comprises:
routing packet requests for the at least one of the plurality of ranges of multicast addresses to the first interface when the first interface is available; and
routing packet requests for the at least one of the plurality of ranges of multicast addresses to the second interface when the first interface is not available.

12. The method of claim 10, wherein routing packet requests comprises:
assigning a primary priority level having a first metric to the first interface;
assigning a secondary priority level having a second metric higher than the first metric to the second interface; and
routing packet requests to the available interface having the lowest metric.

13. A method of operating an internet groups management protocol proxy, comprising:
assigning a range of multicast addresses to a first interface having a first priority metric;
assigning the range of multicast addresses to a second interface having a second priority metric of lower priority than the first priority metric.

14. The method of claim 13, and further comprising:
routing packet requests for the range of multicast addresses to the first interface when the first interface is available; and
routing packet requests for the range of multicast addresses to the second interface when the first interface is not available.

15. A machine readable medium comprising machine readable instructions for causing a computer to perform a method comprising:
enabling a first interface containing a range of multicast addresses;
enabling a second interface containing the range of multicast addresses;
routing packet requests for the range of multicast addresses to the first interface when the first interface is available; and
routing packet requests for the range of multicast addresses to the second interface when the first interface is not available.

16. A machine readable medium comprising machine readable instructions for causing a computer to perform a method comprising:
configuring a range of multicast proxy addresses to a first upstream interface having a first metric; and
configuring the range of multicast proxy addresses to a second upstream interface having a second metric greater than the first metric.

17. The machine readable medium of claim 16, wherein the method further comprises:
monitoring the first upstream interface for availability; and
switching a multicast to the second upstream interface when the first upstream interface becomes unavailable.

18. A method for providing multiple interfaces in IGMP Proxy, comprising:
assigning a primary priority level to a first interface on the IGMP Proxy;
assigning a secondary priority level to a second interface on the IGMP Proxy;
monitoring a status of the first interface; and
switching to the second interface when the first interface is unavailable.

19. The method of claim 18, and further comprising:
monitoring the status of the first interface after the first interface becomes unavailable; and
switching back to the first interface when the first interface becomes available.

20. A router, comprising:
a router body having a plurality of network connections, router memory, and router control circuitry; and
a machine readable medium, stored in router memory and operable by router control circuitry, the machine readable medium comprising machine readable instructions for causing the router to execute a method comprising:
providing a plurality of proxy interfaces for a plurality of multicast proxy address ranges; and
configuring the plurality of proxy interfaces based on the plurality of address ranges.
